(19) United States
(12) Patent Application Publication
(10) Pub. No.: US 2024/0418411 A1
(43) Pub. Date: Dec. 19, 2024

(54) SUPPORT ELEMENT FOR SUPPORTING A SOLAR MODULE

(71) Applicant: SCHLETTER INTERNATIONAL B.V., Amsterdam (NL)

(72) Inventors: Cedrik ZAPFE, Grafing (DE); Tilmann ELSNER, Piding (DE); Korbinian BRAUNERSREUTHER, Pfaffing (DE)

(21) Appl. No.: 18/698,561

(22) PCT Filed: Oct. 5, 2022
(86) PCT No.: PCT/EP2022/077704

§ 371 Date: Apr. 4, 2024

(30) Foreign Application Priority Data
Oct. 5, 2021 (DE) 10 2021 125 841.3

(51) Int. Cl. F24S 25/634; F16B 7/22

(52) U.S. Cl. CPC F24S 25/634; F16B 7/22

(57) ABSTRACT

The present invention relates to a support system for supporting a solar module, wherein the support element (10) includes at least one first coupling portion (12) and at least one second coupling portion (14), the at least one first coupling portion (12) being provided with at least one hooking receptacle (18) and at least one locking formation (16), the at least one locking formation (16) being formed on an outer face and/or an inner face of the support element (10).

The present invention relates to a support element for supporting a solar module. Furthermore, the present invention relates to a support system for attaching solar modules to a roof, in particular to a flat roof.

It is an object of the present invention to provide a support element for supporting a solar module which can be used flexibly as well as being able to be connected quickly and easily to other support elements.

This object is solved with a support element for supporting a solar module with the features of patent claim 1.

Further embodiments are specified in the dependent claims.

The support element for a support system for supporting a solar module is provided with at least one first coupling portion and at least one second coupling portion. The at least one first coupling portion has at least one hooking receptacle and at least one locking formation, wherein the at least one locking formation is formed on an outer face and/or an inner face of the support element.

With the at least one first coupling portion, the support element can be connected to a corresponding support element without additional fastening means being necessary. The connection is solely made via the at least one hooking receptacle and the at least one locking formation. The at least one hooking receptacle can define a pivot point or a pivoting range about which the support element can be pivoted to interlock with a corresponding support element. The at least one second coupling portion can be formed so that it can be used to be connected to a further support element and/or coupled to a solar module. The two coupling portions thus allow a flexible connection of the support element with other components of a support system for solar modules.

The at least one first coupling portion can be provided with at least one longitudinal channel, which is formed to accommodate at least one connecting member. The connecting member can be used, for example, to connect to a base rail. The connecting member can be held in the longitudinal channel in a torque-proof manner via an interference fit. The at least one first coupling portion can thus be used not only for connection to a corresponding support element but as connection to a connecting element or to a base rail as well. The first coupling portion can thus form a variable point of connection.

The at least one longitudinal channel can be arranged between the at least one locking formation and the at least one hooking receptacle. The at least one longitudinal channel can be arranged in a direction parallel to the bottom of the support element between the at least one locking formation and the at least one hooking receptacle. The at least one longitudinal channel may be provided with at least one channel opening. The at least one channel opening may extend between the at least one hooking receptacle and the at least one locking formation. The at least one longitudinal channel may be provided with retaining edges which fix the at least one channel opening between them. The at least one locking formation may be provided on the outer face of a wall of the at least one longitudinal channel.

The at least one locking formation can have at least one latching lug. The at least one locking formation can have at least one locking projection. The at least one locking formation may have at least one lead-in chamfer. The at least one lead-in chamfer may extend between the bottom of the support element and the latching lug. The at least one latching lug and the at least one locking projection can extend outwards. The at least one latching lug and the at least one locking projection can fix at least one latching recess between them.

The at least one hooking receptacle can be open to the outside. The at least one hooking receptacle can be arranged in the area of a sidewall of the support element. The opening of the at least one hooking receptacle can extend between the bottom of the support element and the sidewall. The at least one hooking receptacle can be curved. The curvature of the hooking receptacle can serve to form a pivot point or a pivoting range.

The at least one second coupling portion can be formed so that it forms a receptacle for a first coupling portion of a corresponding support element. The at least one second coupling portion can have at least one locking formation, which is formed on an outer face or on an inner face of the at least one support element. The locking formation can have at least one locking projection. The at least one locking formation can extend from an inner face of a sidewall of the support element in the direction of an opposite sidewall. At least one support section can be provided on one of these sidewalls, which can serve to support a support element interlocked with the locking formation.

The at least one second coupling portion can be provided with an inward-facing hook. The inward-facing hook can be located at the end of a sidewall of the support element. The locking formation and the hook can face each other. The at least one hook may be curved. The at least one inner locking formation and the at least one hook can be directed towards each other.

The first coupling portion or the second coupling portion can be provided with at least one curved sidewall portion. The curved sidewall portion can form an end portion of a sidewall of the support element. The curved sidewall portion can be curved inwards or outwards. The curved sidewall portion can be curved inwards towards the opposite sidewall of the support element. The curved sidewall portion can extend in the direction of the free end of the sidewall. The at least one locking formation can be formed on the at least one curved sidewall portion. The curvature of the end wall portion can achieve a kind of pretension, as the curved sidewall portion can first be moved outwards and then snap inwards when interlocking with a corresponding support element, so that the locking formations of the corresponding support elements can create a form fit. Such a connection can also be referred to as click connection.

The at least one locking formation, the at least one hooking receptacle and the at least one longitudinal channel of the first coupling portion can be arranged together at one end range of the support element. The second coupling portion can be provided at an end range of the support element opposite to the first coupling portion.

The first coupling portion and the second coupling portion can be connected to each other in an articulated manner. The first coupling portion or the second coupling portion can be provided with at least one axle mount. The respective other first or second coupling portion can have at least one axle portion, which is accommodated in the at least one axle mount. The second coupling portion can be provided with a support portion for supporting a solar module. The articulated connection between the first coupling portion and the second coupling portion enables the solar module to be supported flat on the support surface of the second coupling portion.

The second coupling portion can be provided with a bearing portion for a frame of a solar module. The at least one bearing portion can be provided with a bearing surface on which the frame of the solar module can rest. The at least one bearing portion can have at least one longitudinal channel. The channel opening of the longitudinal channel can be delimited by retaining edges of the longitudinal channel.

The present invention further relates to a connecting profile for connecting at least two rails. The connecting profile is provided with at least one holding member. The holding member has at least one claw, which is formed to hold the connecting profile on at least one of the rails.

The at least one connecting profile can be configured such that it can be coupled to at least one of the rails by means of a translatory movement. For example, the at least one connecting profile can be formed such that the connecting profile can be brought into engagement with at least one of the rails. The connecting profile can have at least one guideway in which the rails can engage. This allows the rails to be pushed onto the connecting profile at least in sections. Alternatively, it is also possible for the at least one connecting profile to be formed so that it can be inserted into at least one of the rails. The connecting profile can be formed in the shape of a rail.

The at least one connecting profile can further be provided with at least one stop element. The at least one stop element can define an end position for at least one of the two rails on the at least one connecting profile. The at least one stop element can define the end position for the two rails on the connecting profile. If the two rails are connected with the connecting profile, the at least one stop element can be arranged between the ends of the two rails.

The at least one claw can be formed so that it prevents a relative movement between the connecting profile and one of the rails in at least one direction. The at least one claw can extend obliquely or at an angle to the connecting profile.

The at least one holding member can have at least two claws. The at least two claws can extend towards each other. At least one stop element may be provided between two of the claws. The claws can extend obliquely towards the at least one stop element. The inclined extension of the at least one claw enables the connecting profile to be pushed onto or inserted into the rail in the direction of push-on or insertion. In the opposite direction, the at least one claw can hook into the rail and thus prevent the rail or the connecting profile from moving in the release direction, which is opposite to the push-on or insertion direction.

The at least one holding member can be attached to an upper side or a bottom side of the at least one connecting profile. The holding member can be attached to the connecting profile via a crimp connection. The at least one holding member can be attached to the connecting profile via a form fit. For example, a pin can be formed on the connecting profile. This pin can engage in an opening on the holding member in order to hold the at least one retaining element on the connecting profile. Additionally or alternatively, a projection or a pin-like element can be formed on the holding member, which extends into the connecting profile in order to establish a connection between the at least one holding element and the connecting profile.

The present invention further relates to a connecting system with a connecting profile of the type described above and at least one rail. The connecting profile and the at least one rail can be formed correspondingly in order to be connectable via a translatory movement.

The rails to be connected via the connecting profile can be two base rails or two profile rails.

The present invention further relates to a support system for a solar module, in particular for mounting solar modules on a flat roof. The support system comprises at least one support element of the type described above and at least one base rail which can be connected to the at least one support element.

The support system can have several support elements. At least two support elements, which work together to support a solar module, can be arranged on the at least one base rail.

The support system can have at least one support rail for supporting ballast weights. Additionally or alternatively, the at least one base rail can be formed to support ballast weights. The at least one support rail can be coupled to the at least one base rail.

The support system can have at least one connecting profile for connecting two rails. The rails that are to be connected with a connecting profile can be profile rails or base rails of the type described above.

The support system can be formed to support frameless solar modules or framed solar modules that are provided with a frame. In the latter case, the frame can be understood as part of the solar module. The solar modules can be held on the support system via one or more module clamps.

Exemplary embodiments of the invention are described below with reference to the accompanying figures. They illustrate:

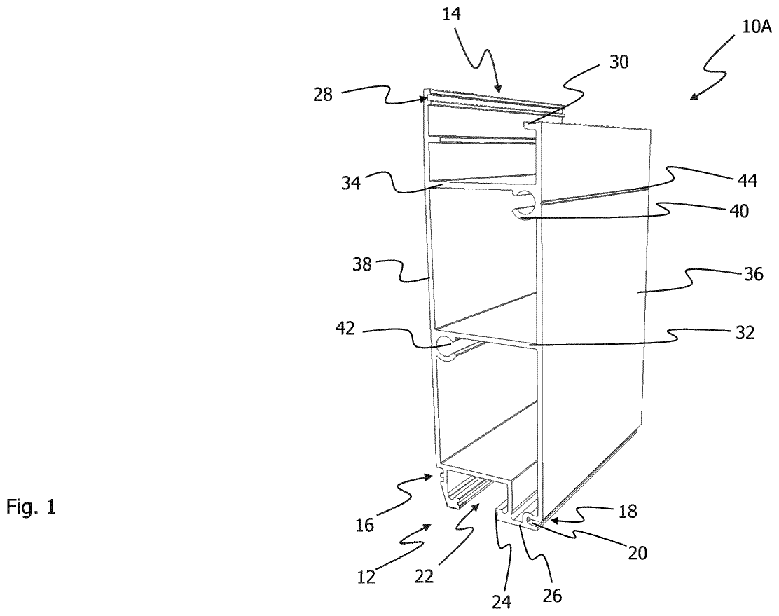

FIG. 1 a perspective view of a support element according to one embodiment of the invention;

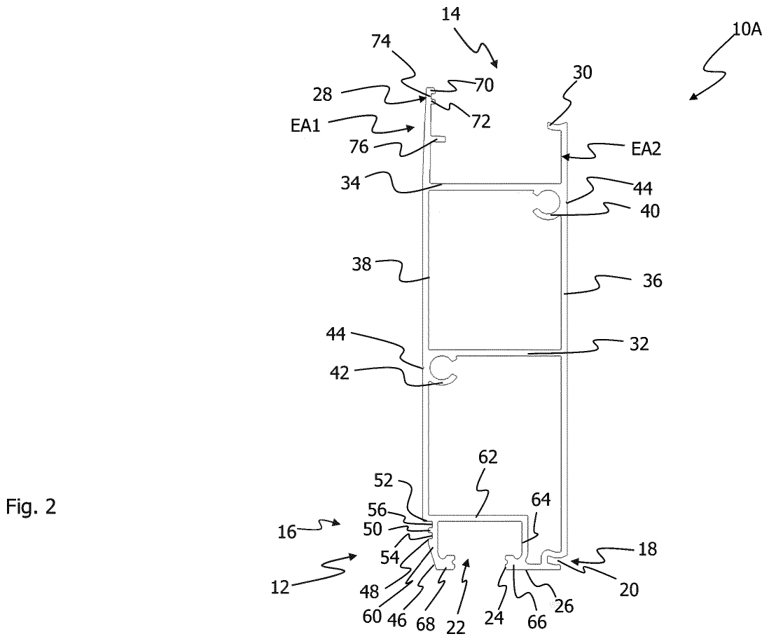

FIG. 2 a front view of the support element according to FIG. 1;

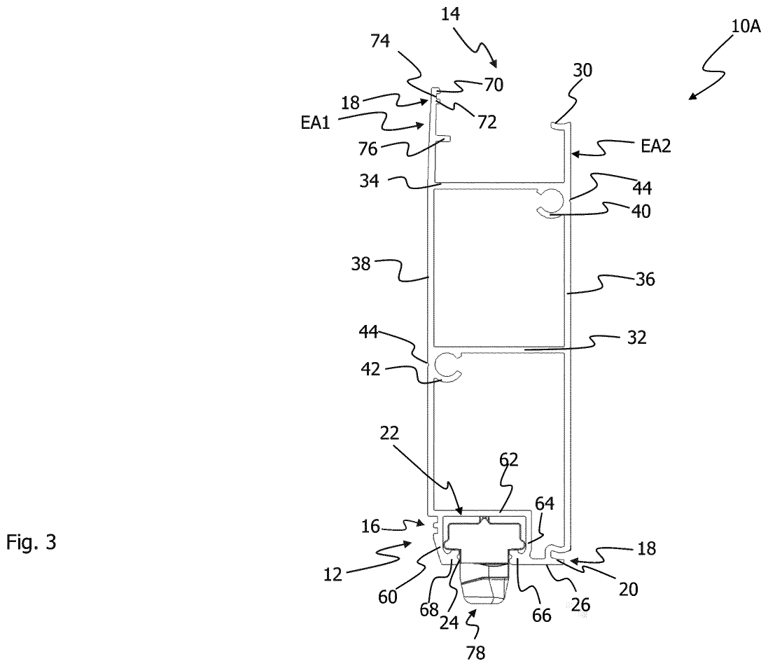

FIG. 3 a front view of the support element according to FIGS. 1 and 2 with an inserted connecting element;

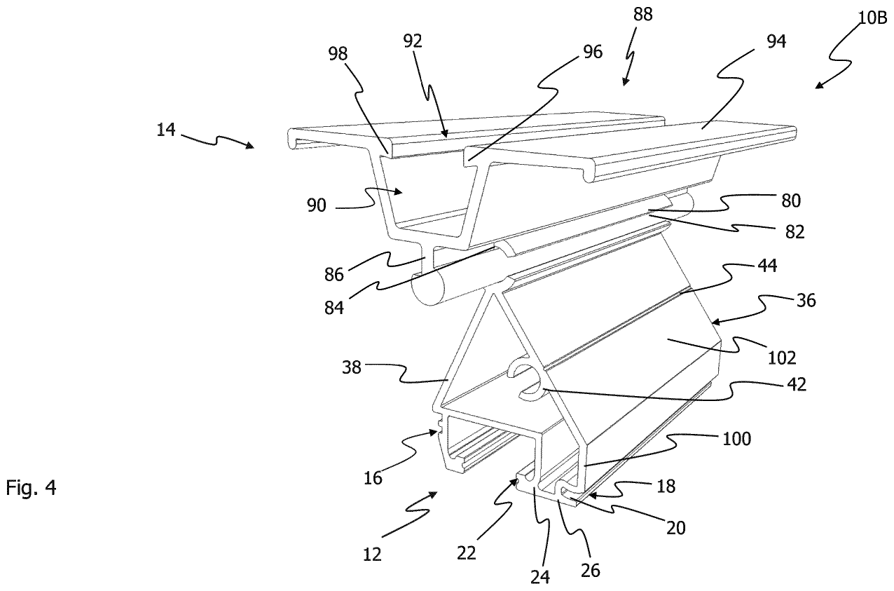

FIG. 4 a perspective view of a support element according to a further embodiment of the invention;

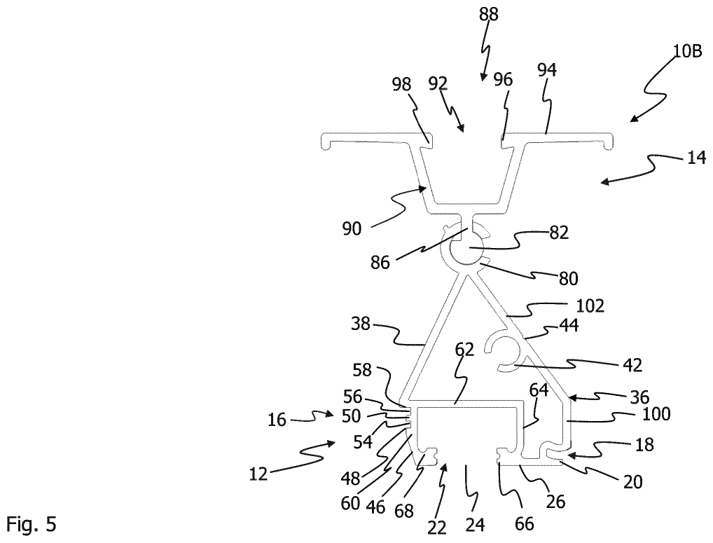

FIG. 5 a front view of the support element according to FIG. 4;

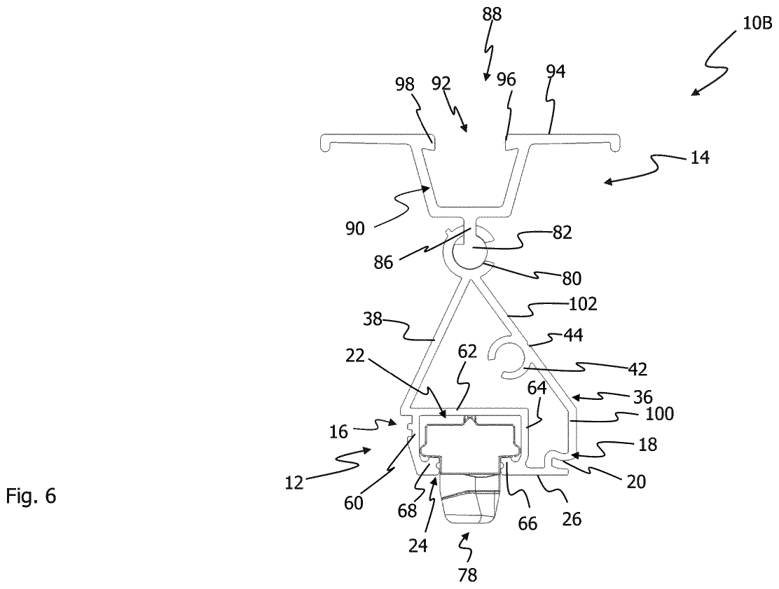

FIG. 6 a front view of the support element according to FIGS. 4 and 5 with an inserted connecting member;

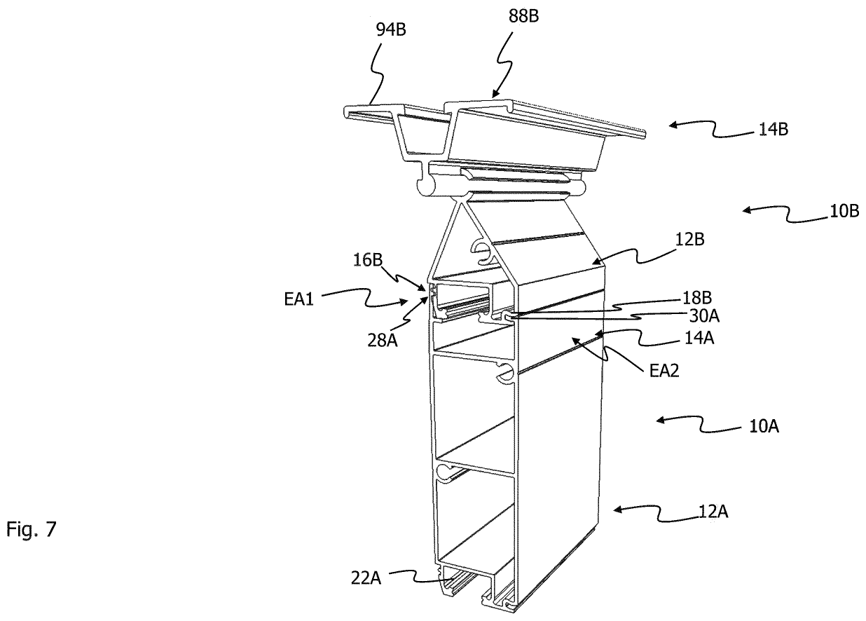

FIG. 7 a perspective view of a support element according to FIGS. 1 and 2 and of a support element according to FIGS. 3 and 4 in the connected state;

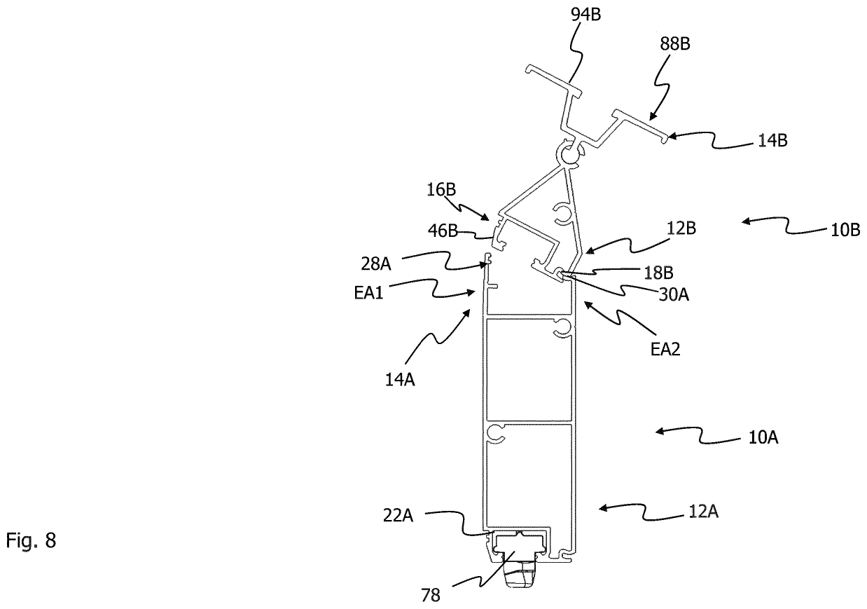

FIG. 8 a front view of a support element according to FIGS. 1 and 2 and of a support element according to FIGS. 3 and 4 during the connection of the two support elements;

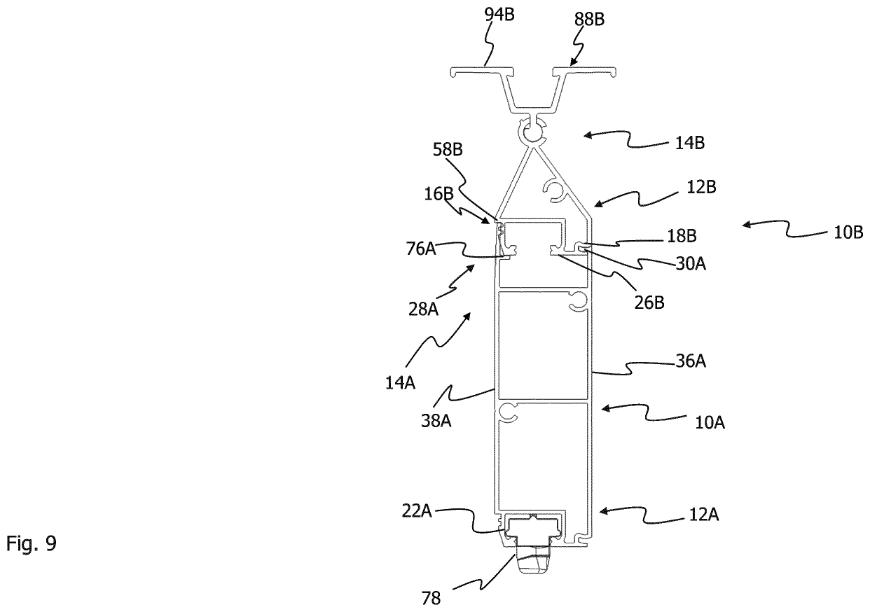

FIG. 9 a front view of a support element according to FIGS. 1 and 2 and a support element according to FIGS. 3 and 4 in the connected state;

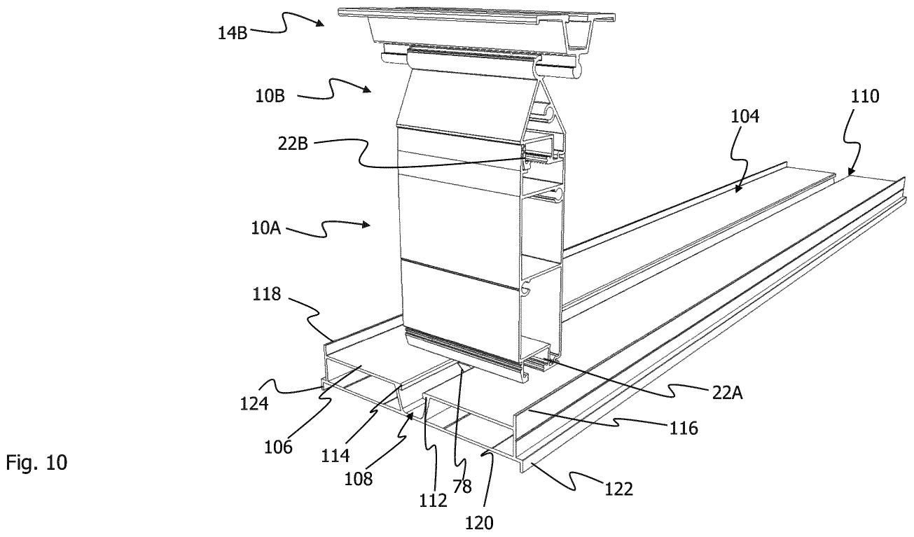

FIG. 10 a perspective view of a support element according to FIGS. 1 and 2 and a support element according to FIGS. 3 and 4 in a state attached to a base rail;

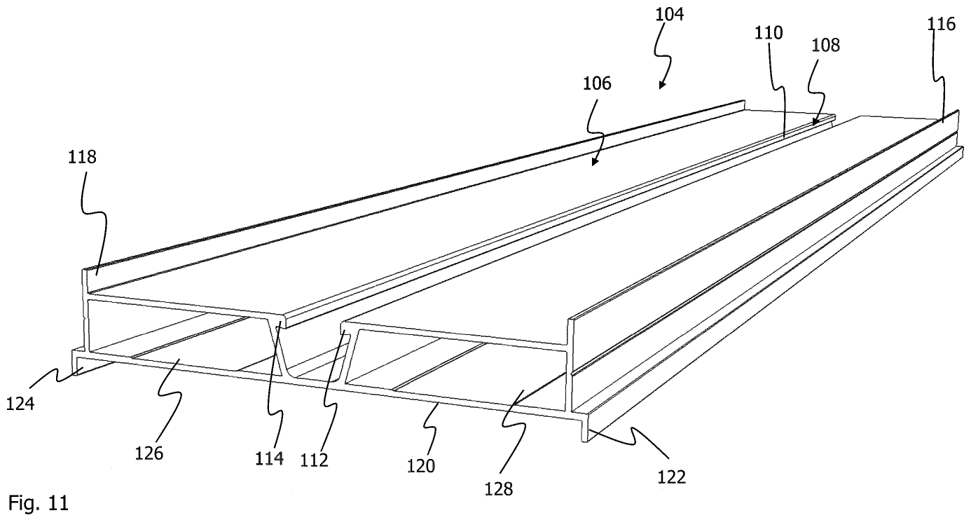

FIG. 11 perspective view of the base rail;

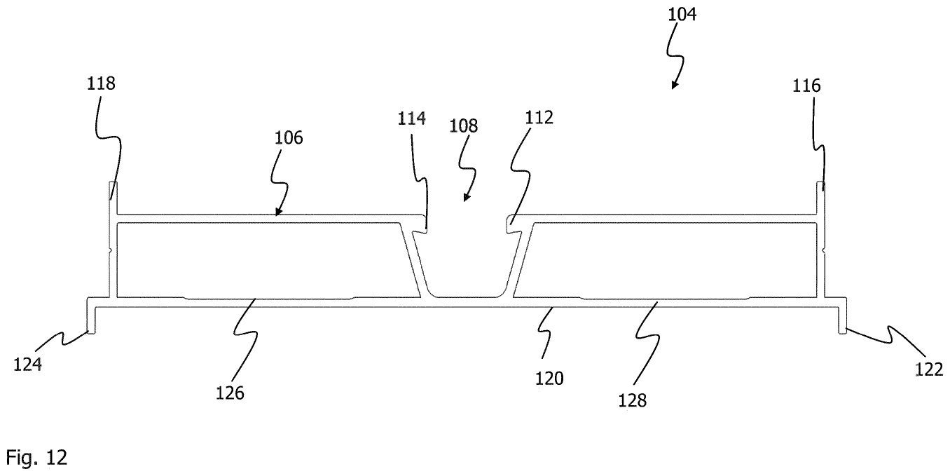

FIG. 12 a front view of the base rail;

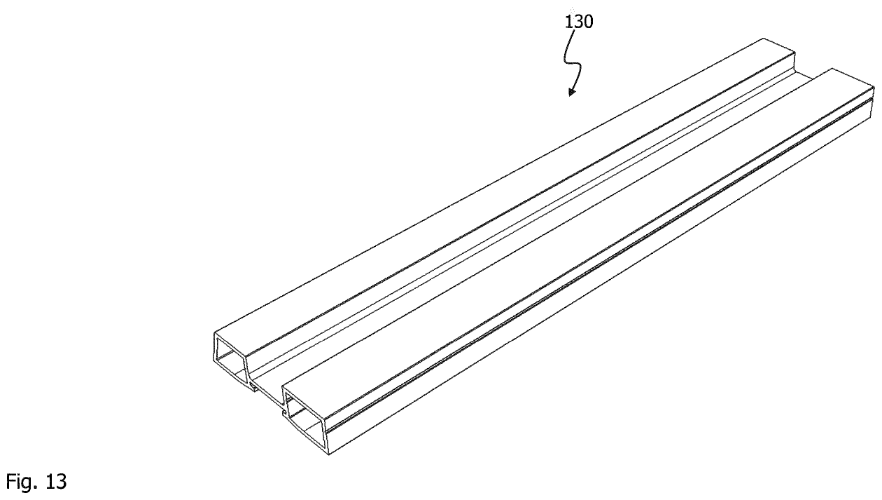

FIG. 13 a perspective view of a connecting profile according to an implementation;

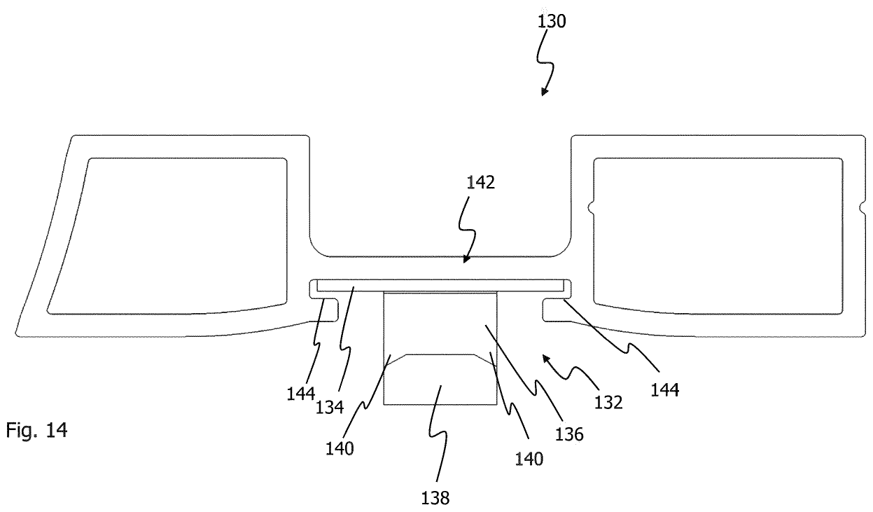

FIG. 14 a front view of the connecting profile according to FIG. 13;

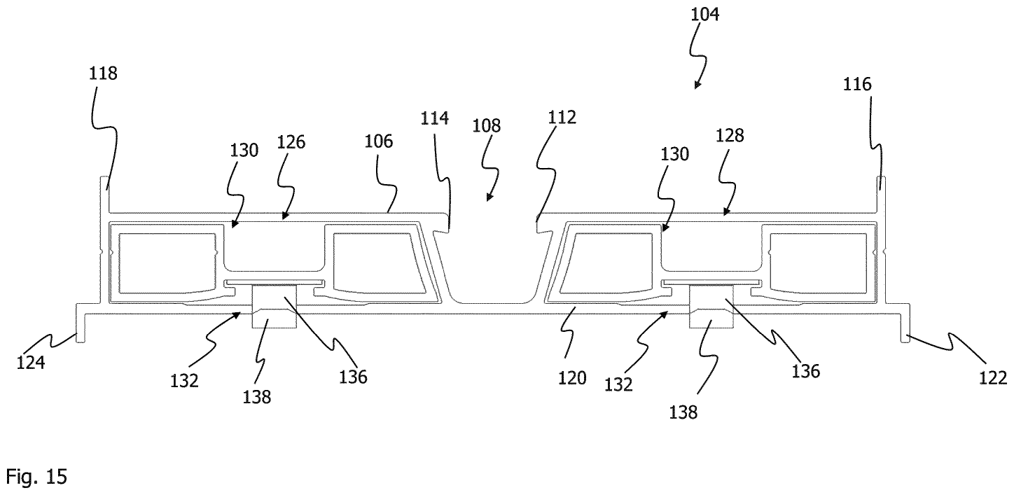

FIG. 15 a view of a base rail according to FIG. 11 with two connecting profiles according to FIGS. 13 and 14 in the assembled state;

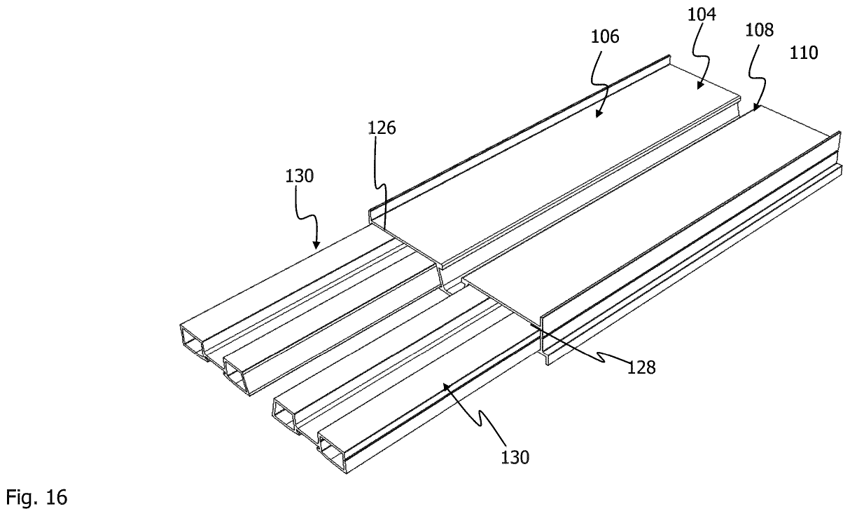

FIG. 16 a perspective view of the base rail according to FIG. 15 with the two connecting profiles;

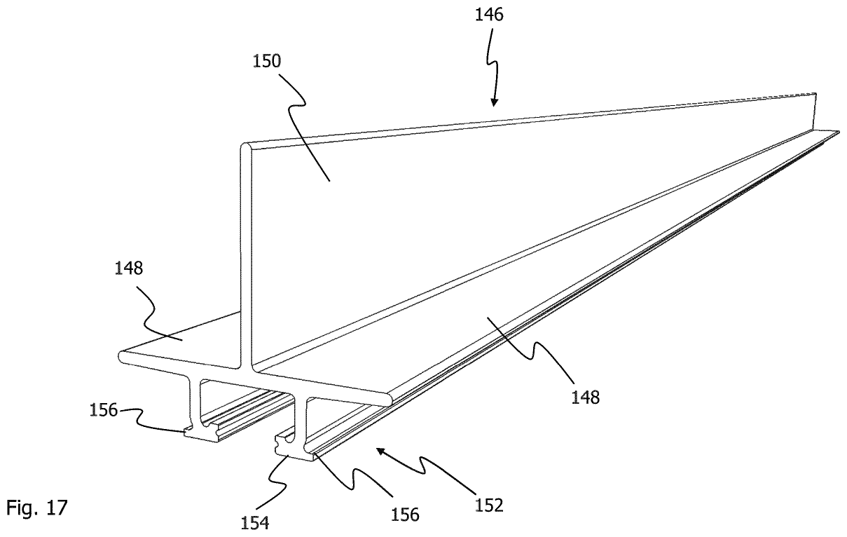

FIG. 17 a perspective view of a profile rail;

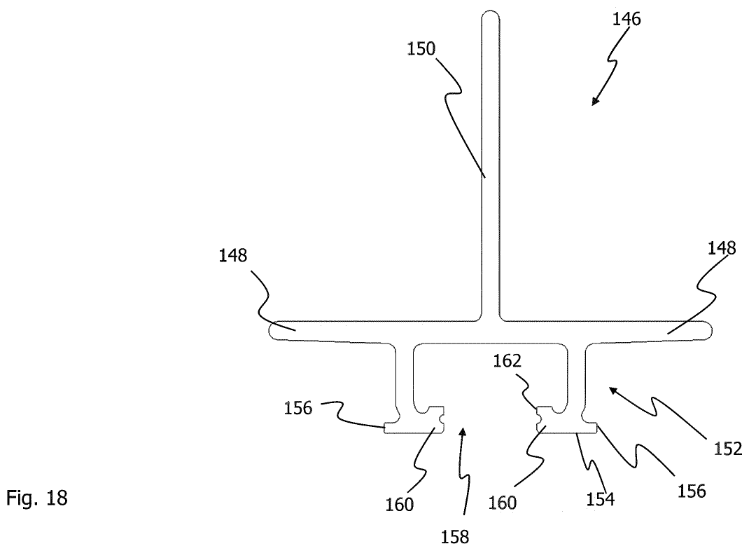

FIG. 18 a front view of the profile rail according to FIG. 17;

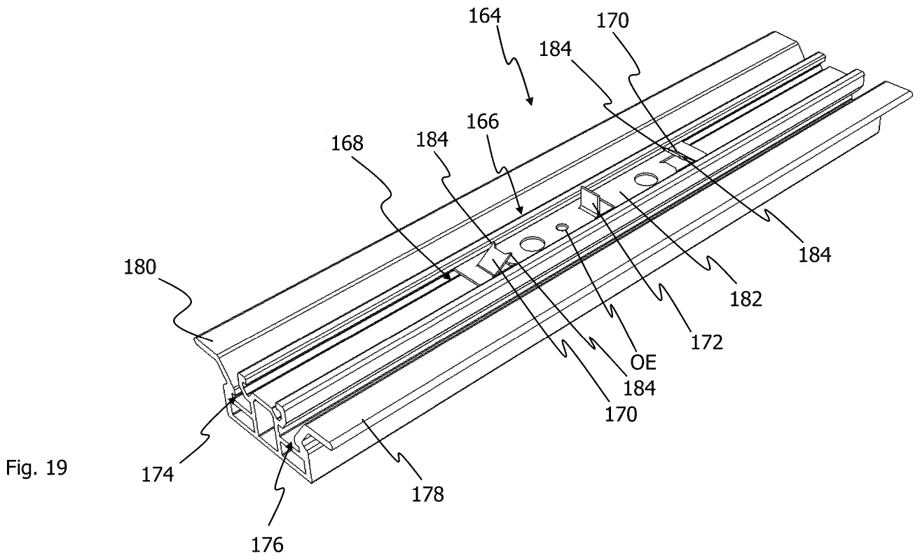

FIG. 19 a perspective view of a connecting profile according to a second implementation;

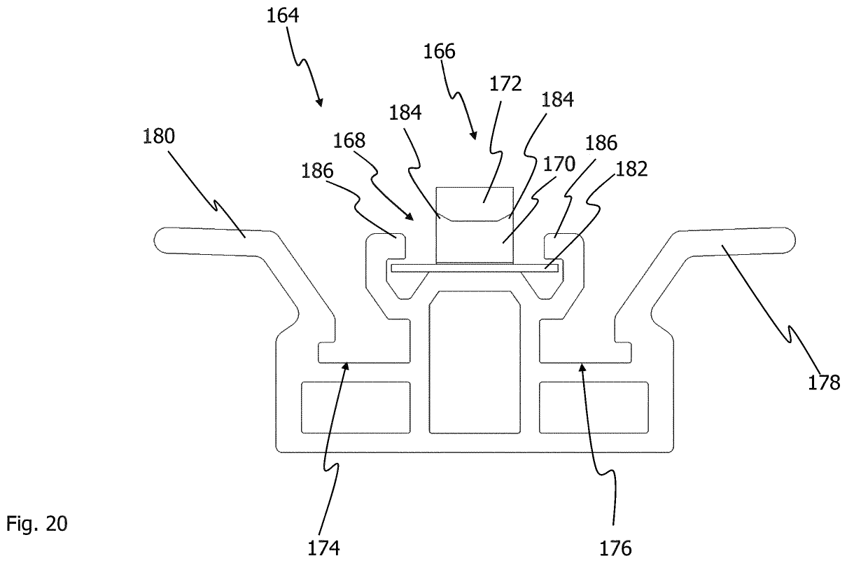

FIG. 20 a front view of the connecting profile according to FIG. 19;

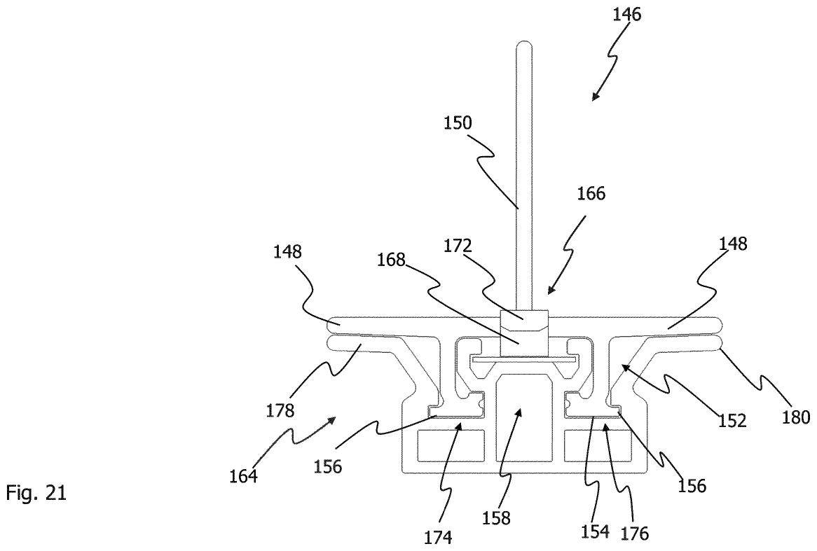

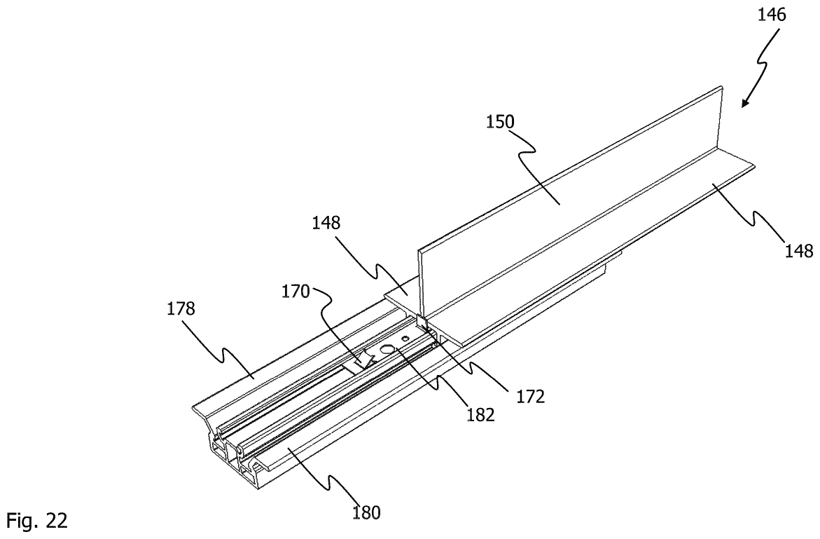

FIGS. 21 and 22 views of a profile rail and a connecting profile in the assembled state;

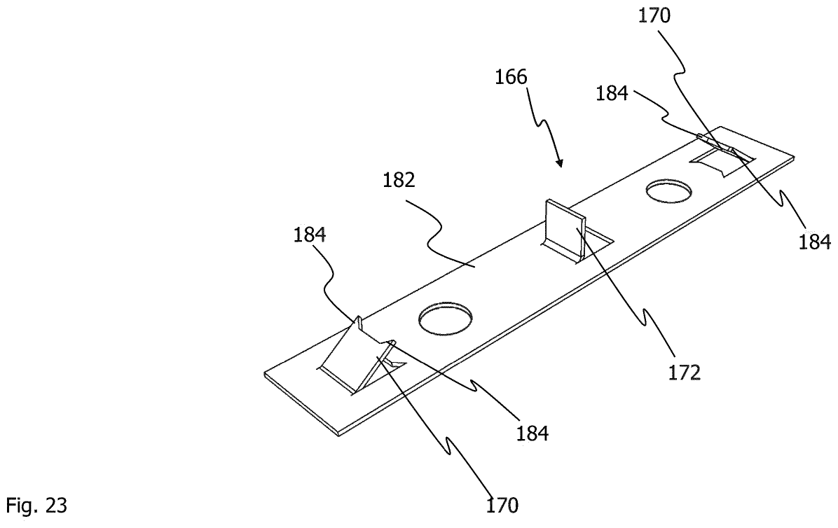

FIG. 23 a perspective view of a holding member for the connecting profiles according to the first and second implementation;

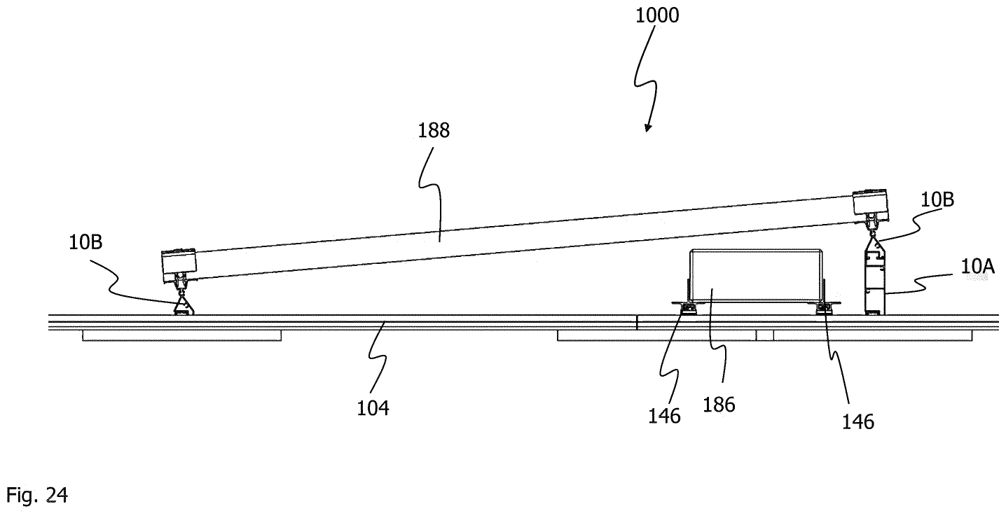

FIGS. 24 to 26 views of support systems with different angles;

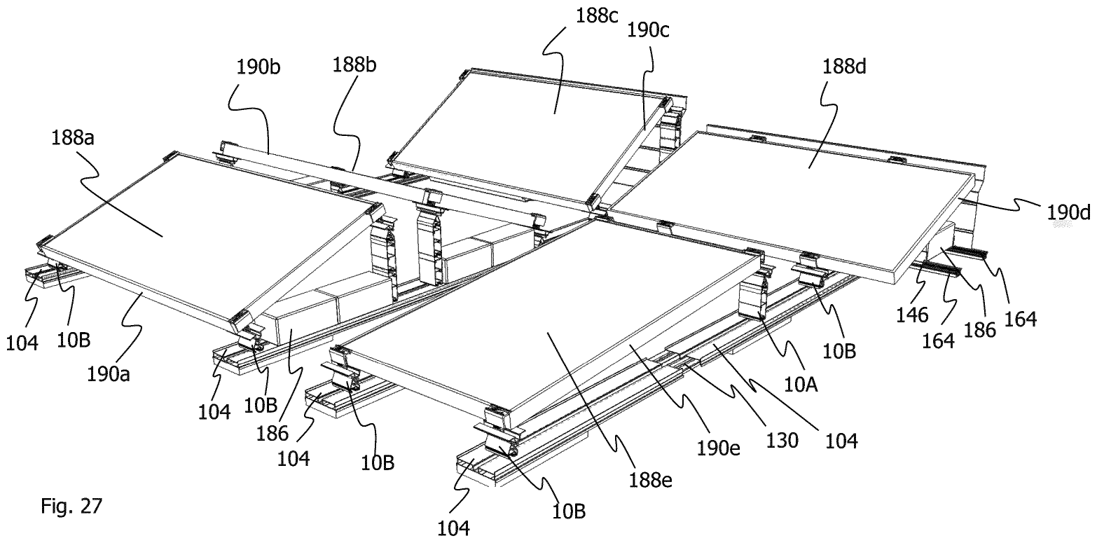

FIG. 27 a perspective view of various possible arrangements of solar modules with the support system according to the invention; and

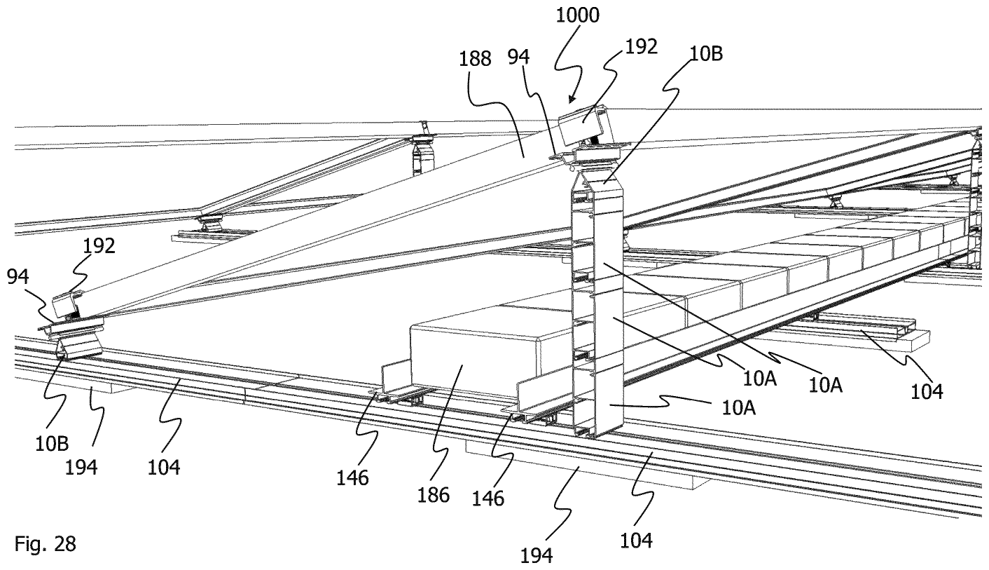

FIG. 28 a further perspective view of a support system according to the invention.

FIG. 1 shows a perspective view of a support element 10A according to a first embodiment. The support element 10A is formed as a profile element. In particular, the support element 10A is designed as a hollow section. The support element 10A is provided with a first coupling portion 12 and a second coupling portion 14. The first coupling portion 14 comprises an outer locking formation 16 and a hooking receptacle 18. The outer locking formation 16 is formed on an outer face of the support element 10. The hooking receptacle 18 is open to the outside and is accordingly provided with an opening 20. The opening 20 and the outer locking formation 16 are provided on opposite outer faces of the support element 10. A longitudinal channel 22 for a connecting element (not shown) is provided between the outer locking formation 16 and the hooking receptacle 18. The longitudinal channel 22 is provided with a channel opening 24. The channel opening 24 is formed on the bottom 26 of the support element 10A. The channel opening 24 is formed between the outer locking formation 16 and the hooking receptacle 18. With the bottom 16 or the bottom surface belonging to the bottom, the support element 10A can be fastened to a base rail not shown.

The second coupling portion 14 is provided with an inner locking formation 28 and a hook 30. The inner locking formation 28 is provided on an inner face of the support element 10A. The inner locking formation 28 and the hook 30 are directed towards each other. The hook 30 is curved in order to support a pivoting movement for interlocking with a corresponding support element (not shown).

The support element 10A is provided with two webs 32 and 34, which connect the sidewalls 36 and 38 of the support element 10. The support element 10A is further provided with screw channels 40 and 42 for cable ducts and/or additional elements. The screw channels 40, 42 are arranged in the interior of the support element 10. Each screw channel 40, 42 is provided with a slot shaped opening. The screw channels 40, 42 are each provided at a transition between one of the webs 32, 34 and the inside of one of the sidewalls 36, 38. A groove 44, which extends along the sidewall, can be seen on the sidewall 36. The groove 44 indicates the position of the screw channel 40 inside the support element 10. In other words, the groove 44 indicates the position and the route of the screw channel 40 inside the support element 10A. The position of the screw channel 42 is also indicated by a groove on the outer face of the sidewall 38. However, this groove is not completely visible in FIG. 1.

The first coupling portion 12 and the second coupling portion 14 are arranged at opposite end sections of the support element 10. The webs 32, 34 and the screw channels 40, 42 described above are provided between the two coupling portions 12 and 14. The first coupling portion 12 can be provided at a lower end region according to FIG. 1 and the second coupling portion 14 can be provided at an upper end region according to FIG. 1.

FIG. 2 shows a front view of the support element 10A. The two coupling portions 12 and 14 of the support element 10A are provided at opposite end regions of the support element 10A. The outer locking formation 16 of the first coupling portion 12 is provided with a lead-in chamfer 46, a latching lug 48 and a locking projection 50. The guide-in chamfer 46 extends between the bottom 26 of the support element 10 and the latching lug 48, i.e. the lead-in chamfer 46 merges into the locking projection 48. The latching lug 48 and the locking projection 50 extend outwards. Latching receptacles 54 and 56 are formed between the latching lug 48, the locking projection 50 and a recess 52, which forms the transition into the sidewall 38. The latching receptacles 54, 56 can serve to receive corresponding latching elements on a support element not shown.

The outer locking formation 16 is formed on the outer face of a wall 60 of the longitudinal channel 22. In addition to the wall 60, the longitudinal channel 22 is provided with a channel base 62, a wall 64 and retaining edges 66 and 68. The retaining edges 66 and 68 are part of the bottom 26 of the support element 10A. The retaining edges 66 and 68 define the channel opening 24 between them. A connecting element (not shown) can engage the retaining edges 66 and 68. The wall 64 has a predetermined gap to the sidewall 36 of the support element 10A. The hooking receptacle 18 is provided between the base 26 and the sidewall 36, i.e. the opening 20 of the hooking receptacle 18 extends between the bottom 26 and the sidewall 36 of the support element 10A. The hooking receptacle 18 is curved in order to support a pivoting movement between the support elements 10A that are to be connected.

The second coupling portion 14, i.e. the upper coupling portion, has the inner locking formation 18. The inner locking formation 18 comprises two locking projections 70 and 72. The locking projections 70 and 72 define a latching receptacle 74 between them. The locking projections 70 and 72 are provided on the sidewall 38 and extend inwardly. A support projection 76 is also provided on the sidewall 38, which serves to support a support element (not shown) latched to the locking formation 18. The supporting projection 76 extends inwards as well. The hook 30 is provided on the sidewall 36. The hook 30 extends inwards. The projections 70, 72, 76 on the sidewall 38 and the hook 30 on the sidewall 36 extend towards each other.

The inner locking formation 28 and the supporting projection 76 are formed on a sidewall section EA1 of the sidewall 38. The sidewall section EA1 extends from the web 34 in the direction of the free end of the sidewall 38. The inner locking formation 28 is formed at the free end of the sidewall 38. The sidewall section EA1 is curved inwards. The curvature begins almost at the web 34 and continues to the free end of the sidewall 38. Due to the curvature of the end wall section EA1, the effect of a pretensioned spring can be achieved, as the sidewall section EA1 is first moved outwards when interlocking with a corresponding support element before the inner locking formation 28 establishes a form fit with an outer locking formation of a corresponding support element (not shown).

The hook 30 is formed on an end wall section EA2 of the sidewall 36. The end wall section EA2 extends from the web 34 in the direction of the free end of the sidewall 36. The hook 30 is formed at the free end of the sidewall 36.

The sidewall sections EA1 and EA2 form a receptacle which can receive a first coupling portion of a further corresponding support element (not shown) and can be interlocked with it. If a corresponding hook (not shown) of a corresponding support element is brought into engagement with the hooking receptacle 18, a pivoting movement can be executed in order to interlock the two support elements 10 with each other. Due to the coupling portions 12 and 14 of the support element 10, several of the support elements 10 shown in FIGS. 1 and 2 can be connected with each other in order to be able to adjust the height of the solar module above the roof and the angle of the solar module, among other things.

FIG. 3 shows a view of the support element 10A which largely corresponds to the front view shown in FIG. 2. In the view according to FIG. 3, a connecting element 78 has been inserted into the longitudinal channel 22. The connecting element 78 is received torque-proof in the longitudinal channel 22. The connecting element 78 is supported on the walls 60, 64, the channel base 62 and the retaining edges 66, 68 of the longitudinal channel 22.

In the state shown in FIG. 3, the support element 10A forms an assembly with the connecting element 78. The connecting element 78 protrudes from the longitudinal channel 22 through the channel opening 24. For example, the connecting element 78 can be inserted with its section projecting from the channel opening 24 into a corresponding longitudinal channel of a rail (not shown). Through a rotational movement of the support element 10 and the connecting element 78 received therein, the support element 10 can be connected via the connecting element 78 to the rail not shown.

FIG. 4 shows a perspective view of a support element 10B according to a further embodiment. The support element 10B can form a module bearing support on which the solar module can rest. The support element 10B is formed as a profiled element. The support element 10B is provided with a first coupling portion 12 and a second coupling portion 14. The first coupling portion 12 is formed as a hollow section. The second coupling portion 14 is articulately connected with the first coupling portion 12. The first coupling portion 12 has an axle mount 80, which is used for articulated connection to the second coupling portion 14. An axle portion 82 is formed on the second coupling portion 14, which is received at least in sections in the axle mount 80. The axle mount 80 embraces the axle portion 82. The axle mount 80 extends through a slot 84 in a web 86. The web 86 connects the axle portion 82 to a support portion 88 of the second coupling portion 14.

The support portion 88 has a longitudinal channel 90, which is provided with a channel opening 92. In the position of the support element 10B or the second coupling portion 14 shown in FIG. 4, the longitudinal channel 90 opens up in the opposite direction to the longitudinal channel 22 in the bottom 26. The support portion 88 has a support surface 94 on which a solar module (not shown) can rest. The channel opening 92 interrupts the support surface 94. The longitudinal channel 90 is provided with retaining edges 96 and 98, which define the channel opening 92 between them, i.e. which project into the cross-section of the longitudinal channel 90. A module clamp (not shown), for example, can engage on the retaining edges 96 and 98.

The first coupling portion 12 is provided with sidewalls 36 and 38. The sidewalls 36 and 38 converge in the direction of the axle mount 80 or merge into the axle mount 80. The sidewall 36 is provided with a sidewall portion 100, on which the hooking receptacle 18 is formed with its opening 10, and a sidewall section 102, which extends at an angle to the sidewall section 100. The sidewall section 102 extends at an angle between the sidewall section 100 and the axle mount 80. The screw channel 42 is arranged on the sidewall section 102. The screw channel 42 is thus provided inside the support element 10. The position of the screw channel 42 is indicated by the gutter 44 on the outer face of the sidewall section 102.

FIG. 5 shows a front view of the support element 10B as shown in FIG. 4. The support element 10B is provided with the axle mount 80, in which the axle portion 82 of the second coupling portion 14 is accommodated. The axle mount 80 embraces the axle portion 82.

The first coupling portion 12 is provided with the outer locking formation 16. The outer locking formation 16 is formed identically to the outer locking formation 16 described with reference to FIGS. 1 to 3. The statements made above with regard to the outer locking formation 16 therefore apply to the outer locking formation 16 shown in FIGS. 4 and 5 as well.

FIG. 6 shows a view of the support element 10B, which largely corresponds to the front view shown in FIG. 5. As in the case of FIG. 3 described above with respect to the support element 10B, a connecting element 78 has been inserted into the longitudinal channel 22 in the view according to FIG. 5. The connecting element 78 is received torque-proof in the longitudinal channel 22. The connecting element 78 is supported on the walls 60, 64, the channel base 62 and the retaining edges 66, 68 of the longitudinal channel 22. With its section protruding from the channel opening 24, the connecting element 78 can, for example, be inserted into a corresponding longitudinal channel of a rail (not shown). Through a rotary movement of the support element 10B and the connecting element 78 received therein, the support element 10B can be connected via the connecting element 78 to the rail not shown.

FIG. 7 shows a perspective view of the two assembled support elements 10A and 10B. The support element 10A was described with reference to FIGS. 1 to 3. The support element 10B was described with reference to FIGS. 4 to 6. The support elements 10A and 10B are connected with each other via the second coupling portion 14A of the support element 10A and the first coupling portion 12B of the support element 10B. The hooking receptacle 18B of the support element 10B was brought into engagement with the hook 30A of the support element 10A. Subsequently, the support element 10B was tilted so that the inner locking formation 28A of the second coupling portion 14A of the support element 10A could be interlocked with the outer locking formation 16B of the support element 10B. The two support elements 10A and 10B could thus be connected to each other without fastening elements. The longitudinal channel 22A of the first coupling portion 14A of the support element 10A can be used, for example, for connection to a base rail (not shown). The bearing portion 88B of the support element 10B can be connected to a solar module (not shown) of a solar module. In this way, the support elements 10A and 10B can carry and support a solar module. Since the second coupling portion 14B of the support element 10B can be tilted relative to the first coupling portion 12B, the angle of the solar module can also be adjusted via the support element 10B.

FIG. 8 shows a front view of the support elements 10A and 10B before they interlock. This can be seen from the fact that the support element 10B extends at an angle to the support element 10A and the locking formations 16B and 28A are not yet engaged with each other. The hooking receptacle 18B of the support element 10B has been hooked into the hook 30A of the support element 10A. Since both the hook 30A as well as the hooking receptacle 18B are curved, the support element 10B can be pivoted relative to the support element 10A. The pivoting movement allows the outer locking formation 16B of the support element 10B and the inner locking formation 28A of the support element 10A to be interlock. As soon as the lead-in chamfer 46B of the locking formation 16B comes into contact with the inwardly curved sidewall section EA1 or with the locking formation 28A, the curved sidewall section EA1 is pressed outwards. If the inner locking formation 28A of the support element 10A can create a form fit with the outer locking formation 16B of the corresponding support element 10B, the two support elements 10A, 10B are interlocked. This connection can also be referred to as a click connection, as the inwardly curved sidewall section EA1 “snaps” inwards when the form fit is established.

The connecting element 78 is accommodated in the longitudinal channel 22A of the first coupling portion 12A of the support element 10A. A connection to a rail (not shown) can be established via the connecting element 78.

FIG. 9 shows a front view of the support elements 10A and 10B in an interlocked state. It can be seen in FIG. 9 that the base 26B of the support element 10B is supported on the support section 76A. The support element 10B is further supported by the recess 58B on the end face of the sidewall 38A of the support element 10A.

FIG. 10 shows a perspective view in which the assembly formed by the support elements 10A and 10B has been connected to a base rail 104. The base rail 104 is provided with a base face 106 and a longitudinal channel 108. The longitudinal channel 108 is provided with a channel opening 110. The channel opening 110 is delimited by retaining edges 112, 114 of the longitudinal channel 108. Holding webs 116 and 118 are provided on the base face 106. The holding webs 116 and 118 extend at an angle to the base face 106. The holding webs 116 and 118 serve to hold ballast weights on the base rail 104.

Holding webs 122, 124 are provided on the underside 120 of the base rail 104. The holding webs 122, 124 can hold the protective mats (not shown) in their position on the base rail. The protective mats may extend between the holding webs 122, 124. The protective mats serve to protect the roof and, in particular, the insulation of the roof.

The assembly formed by the support elements 10A and 10B is connected to the base rail 104 via a connecting element 78 (see FIGS. 3, 6, 8 and 9). For connection to the base rail 104, initially only the support element 10A, in the longitudinal channel 22A of which the connecting element 78 has been inserted, can be connected to the base rail 104. For this purpose, the support element 10A is aligned parallel to the longitudinal channel 108. In this position, the connecting element 78 can be inserted into the longitudinal channel 108 of the base rail. The support element 10A and thus also the connecting element 78 is then rotated by approximately 90° into the position shown in FIG. 10. This establishes a connection via the connecting element 78 between the support element 10A and the base rail 104, since the connecting element 78 engages behind the retaining edges 112, 114 of the longitudinal channel 108 in this position. Subsequently, the support element 10B is interlocked with the support element 10A so that the state shown in FIG. 10 is achieved. However, it is also conceivable to first connect the support elements 10A and 10B to one another before the connecting element 78 is inserted into the longitudinal channel 108 and the assembly formed by the support elements 10A, 10B and the connecting element 78 is rotated through 90°.

As shown in FIG. 6, the support element 10B can also accommodate a connecting element 78 in its longitudinal channel 22B. This allows the support element 10B to be connected directly to the base rail 104 via the connecting element 78. This is also done by a rotational movement through 90°.

The assembly shown in FIG. 10, which is formed by the support elements 10A, 10B and the connecting element 78, can be attached to the base rail 104 together with the support element 10B shown in FIG. 6 and the connecting element 78, spaced apart from one another in the longitudinal direction of the base rail 104 in order to be able to support a solar module. The angle of the solar module can be adjusted via the pivotable coupling portion 14B.

As already described above, several of the support elements 10A can be connected to each other as well. In this case, a support element 10B can form the upper end of the assembly.

The support elements 10A and 10B can be put together like building blocks in order to adjust the height and angle of the solar module. The support elements 10A and 10B can be connected variably to each other via their coupling portions so that the height above the flat roof and the angle of the solar module can be adjusted flexibly. Regardless of whether several support elements 10A are to be connected to each other or one support element 10A is to be connected to a support element 10B, the support elements 10A, 10B can be attached without fastening means. The connection is solely made by interlocking the corresponding support elements 10A, 10B via the described pivoting movement.

FIGS. 11 and 12 show views of a base rail 104. The base rail 104 has a base surface 106 and a longitudinal channel 108. The base surface 106 is bounded by retaining webs 116 and 118. The base surface 106 can serve as a bearing surface for ballast weights (not shown). The holding webs 116 and 118 can hold the ballast weights on the base rail 104. In addition, the base rail 104 is provided with receptacles 126 and 128 in which a connecting profile or a connecting rail can be received, at least in sections. The receptacles 126 and 128 are arranged laterally next to the longitudinal channel 108.

FIG. 13 shows a perspective view of a connecting profile 130, which can, for example, be accommodated in one of the receptacles 126 or 128. The connecting profile 130 is rail shaped. The connecting profile 130 can be inserted into one of the receptacles 126 or 128.

FIG. 14 shows a front view of the connecting profile 130. The connecting profile 130 is formed correspondingly to the receptacles 126, 128 of the base rail 104 so that it can be received in the receptacles 126 and 128 of the base rail 104. The shape and the cross-section of the connecting profile 130 are adapted to the receptacles 126 and 128 of the base rail 104.

The connecting profile 130 has a holding member 132. In the implementation shown, the holding member 132 is attached to the underside of the connecting profile 130. The holding member 132 has a fastening section 134. The fastening section 134 is plate shaped. The holding member 132 is further provided with a claw 136 and a stop element 138. The claw 136 has two claw tips 140, which can engage the base rail 104 to hold the connecting profile 130 on the base rail 104. The claw 136 and the stop element 138 extend to the attachment portion 134 at an angle.

The connecting profile 130 has a receptacle range 142, in which the fastening section 134 of the holding member 132 is received. The receptacle range 142 is defined by two projections 144, which extend towards each other. As a result, the fastening section 134 is at least partially enclosed.

FIG. 15 shows a view of a base rail 104 that has been connected with two connecting profiles 130. The connecting profiles 130 have been received in the receptacles 126 and 128 of the base rail 104. The stop element 138 of the connecting elements 130 rests against the base rail 104, so that the connecting profiles 130 can no longer be pushed further into the receptacles 126 and 128.

FIG. 16 shows a perspective view of a base rail 104 into which two connecting profiles 130 have been inserted. The connecting profiles 130 protrude from the receptacles 126 and 128.

FIGS. 17 and 18 show views of a profile rail 146 on which ballast weights (not shown) can rest. The profile rail 146 has two bearing portions 148 for ballast weights, which are separated from each other by a contact section 150. A receiving portion 152 for a connecting profile (not shown) is formed on the underside of the bearing portion 148. The receiving portion 152 has a bottom surface 154 with which the profile rail 146 can rest on a further component. The bearing portion 152 has lateral projections 156 extending in opposite directions from the receiving portion 152. The receiving portion 152 has a longitudinal channel 158 which has retaining edges 160. The retaining edges 160 define the channel opening 162 between them.

FIGS. 19 and 20 show views of a connecting profile 164 which is formed, for example, to connect two of the profile rails 146 shown in FIGS. 17 and 18. The connecting profile 164 has a holding member 166, which is received and fastened in a receptacle 168 formed on the connecting profile 164. The holding member 166 has two claws 170 and a stop element 172. The stop element 172 is arranged between the claws 170. The claws 170 extend at an angle in the direction of the stop element 172.

The connecting profile 164 has two receiving tracks 174 and 176 for the receiving portion 152 of the profile rail 146. The receiving tracks 174 and 176 are formed laterally next to the receptacle 68 for the holding member 166. The connecting profile 164 also has support portions 178 and 180, which can serve to support the bearing portions 148. The support portions 178 and 180 extend laterally outwards from the receiving tracks 174 and 176.

The holding member 166 has a fastening portion 182. The fastening portion 182 is plate shaped. The claw 170 has two claw tips 184, which can engage the profile rail 146 in order to hold the connecting profile 164 on the profile rail 146. The receptacle 168 for the fastening portion 182 of the holding member 166 is defined by two projections 186, which extend towards each other. The fastening portion 182 is provided with a deformation in the OE area in order to establish a connection with the connecting profile 164. This deformation enables the holding member 166 to be held on the connecting profile 164.

FIGS. 21 and 22 show views of the profile rail 146 and the connecting profile 164 in the connected state. The connecting profile 164 has been attached to the profile rail 146. The longitudinal channel 158 accommodates the receiving portion 168 of the connecting profile 164. The receiving tracks 174 and 176 can receive and guide the receiving portion 152 of the profile rail 146. The support portions 178 and 180 can support the bearing portions 148.

FIG. 23 depicts the individual holding member 166. The holding member 166 has two claws 170 and a stop element 172. The stop element 172 is arranged between the claws 170. The claws 170 extend at an angle in the direction of the stop element 172. The holding member 166 has a fastening portion 182. The fastening portion 182 is plate shaped. The claws 170 each have two claw tips 184, which can engage on the profile rail 146 to hold the connecting profile 164 on the profile rail 146. The holding member 132 according to FIG. 14 and the holding member 166 can be formed identically.

FIG. 24 shows a side view of a support system 1000. The support system 1000 comprises support elements 10A and 10B, a base rail 104, profile rails 146, ballast weights 186 and a solar module 188. The profile rails 146 support the ballast weights 186. The solar module 188 is connected to the support elements 10B which, due to their articulation, allow a parallel alignment of their bearing surface to the solar module 188 (see FIGS. 4 to 6). The support element 10B on the right in FIG. 14 is coupled to a support element 10A to raise the right end of the solar module 188 and to set a predetermined angle of the solar module 188. In FIG. 24, an angle of the solar module of 5° is set via the support elements 10A and 10B.

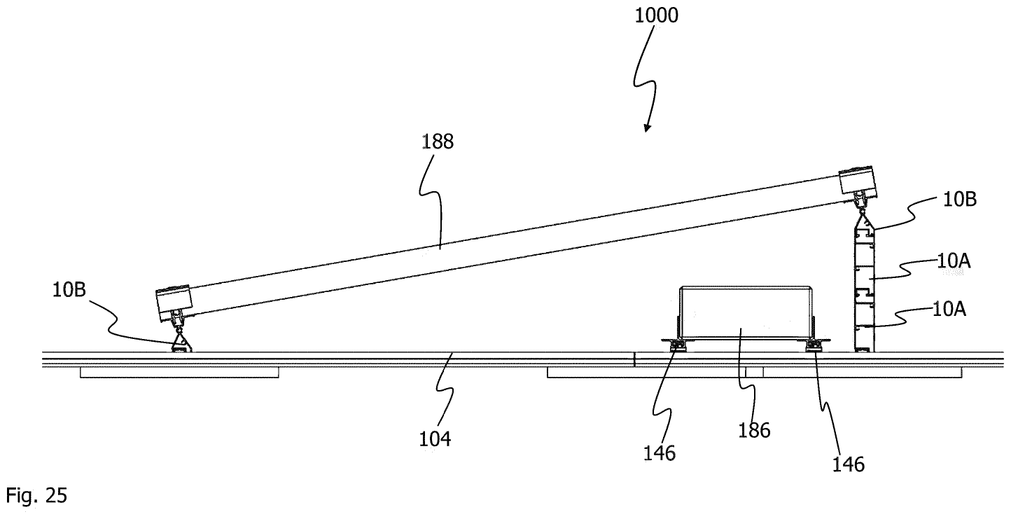

In FIG. 25, two support elements 10A and one support element 10B have been connected with each other. As a result, the right end of the solar module 188 has been raised further. In FIG. 25, an angle of the solar module of 10° is set via the support elements 10A and 10B.

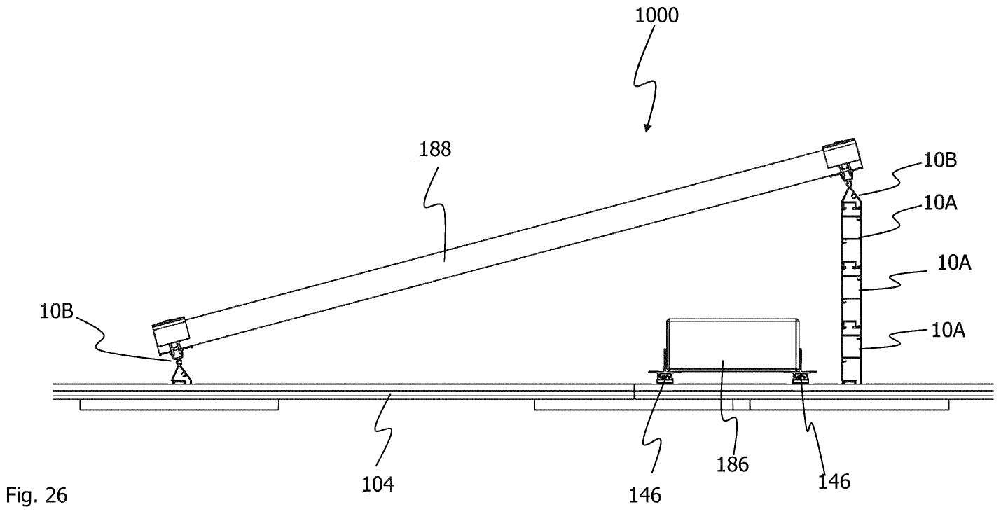

In FIG. 26, three support elements 10A and one support element 10B are connected with each other. This further increases the right-hand end of the solar module 188. In FIG. 26, an angle of the solar module of 15° is set via the support elements 10A and 10B.

FIG. 27 shows various arrangements of solar modules 188a, 188b, 188c, 188d, 188e, which are made possible by the support system according to the invention. In the illustrated implementation, framed solar modules 188a, 188b, 188c, 188d, 188e are shown, each comprising a frame 190a, 190b, 190c, 190d and 190e. However, the support system according to the invention can also be used with frameless solar modules (not shown). The solar modules 188a, 188b, 188c, 188d are arranged in landscape or horizontal format. The solar module 188e is arranged in portrait format or vertically. As can be seen in the case of solar module 188d, the support elements 10A, 10B can also be arranged so that the solar module frame 190d of the solar module 188d rests on the support elements 10B with a central area and not with its corners.

As can be seen in FIG. 27, different angles and different heights of the solar modules 188 can be set by means of the support elements 10A and 10B, which can be assembled like building blocks. It should be emphasized that no additional fastening means are required for adjusting the height and angle of the solar modules 188a, 188b, 188c, 188d, 188e via the support elements 10A and 10B.

In FIG. 27, two base rails 104 are connected to each other via connecting profiles 130. For this purpose, the connecting profiles 130 are inserted into the two base rails 104. The base rails 104 can serve as a support for the ballast weights 186. Two profile rails 146 support each respective ballast weight 186. The connecting profiles 164 are shown on the profile rails 146 in FIG. 27.

FIG. 28 shows a perspective view of a support system 1000. The support system 1000 according to FIG. 28 is provided with the base rails 104, the profile rails 146 and the support elements 10A and 10B. Respectively, two profile rails 146 carry a ballast weight 186. The base rails 104 are connected to one another via a connecting profile not shown. The support profiles 10A and 10B are attached to these two base rails 104. According to FIG. 28, three support elements 10A are connected to each other. The arrangement of three support elements 10A is connected to a support element 10B. The support elements 10B are in contact with the solar module 188. The solar module 188 rests on the bearing surfaces 94 of the support elements 10B. The articulated support elements 10B ensure that the solar module 188 can rest flat on the bearing surface 94 of the support elements 10B. The solar module 188 is held on the support system 1000 via module clamps 192.

FIG. 28 further shows protective mats 194 extending below the base rails 104. The protective mats 194 protect the roof and, in particular, the insulation of the roof so that it cannot be damaged.

1. A support element for a support system for supporting a solar module,
wherein the support element is provided with at least one first coupling portion and at least one second coupling portion, wherein the at least one first coupling portion is provided with at least one hooking receptacle and at least one locking formation, wherein the at least one locking formation (16) is formed on an outer face and/or an inner face of the support element,
wherein the at least one first coupling portion is provided with one longitudinal channel for receiving at least one connecting member,
wherein the at least one longitudinal channel is arranged between the at least one locking formation and the at least one hooking receptacle, and
wherein the first coupling portion is formed so that it can be connected to a corresponding support element as well as to a base rail.

2-3. (canceled)

4. A support element according to claim 1, wherein the at least one longitudinal channel is provided with at least one channel opening, which extends between the hooking receptacle and the at least one locking formation.

5. A support element according to claim 1, wherein the at least one locking formation is formed on the outer face of a wall of the at least one longitudinal channel.

6. A support element according to claim 1, wherein the at least one locking formation is provided with at least one locking projection and/or at least one latching lug, which extend outwards or inwards.

7. A support element according to claim 1, wherein the at least one locking formation, the at least one hooking receptacle and the at least one longitudinal channel are formed together on an end portion of the support element.

8. A support element according to claim 1, wherein the second coupling portion is provided with at least one locking formation, which is formed on an outer face or on an inner face of the at least one support element.

9. A support element according to claim 1, wherein the at least one second coupling portion is provided with at least one inwardly directed hook.

10. A support element according to claim 1, wherein the at least one locking formation is provided with at least one inwardly directed locking projection.

11. A support element according to claim 1, wherein the first coupling portion or the second coupling portion are provided with at least one curved sidewall portion.

12. A support element according to claim 11, wherein the at least one locking formation is formed on the at least one curved sidewall portion.

13. A support element according to claim 1, wherein the first coupling portion and the second coupling portion are articulately joined to one another.

14. A support element according to claim 13, wherein the first coupling portion or the second coupling portion are provided with at least one axle mount, wherein the respective other first or second coupling portion has at least one axle portion, which is received in the at least one axle mount.

15. A support element according to claim 1, wherein the second coupling portion is provided with a support surface for supporting a solar module, wherein the articulated connection between the first coupling portion and the second coupling portion allows the solar module to be supported flat on the support surface.

16-23. (canceled)

24. A support system for attaching a solar module to a roof, in particular to a flat roof, wherein the support system is provided with at least one support element according to claim 1 and at least one base rail, which can be connected to the at least one support element.

25. A support system according to claim 24, wherein the support system is provided with several support elements, wherein at least two support elements are arranged on the at least one base rail cooperating to support a module frame of a solar module.

26. A support system according to claim 24, wherein the support system is provided with at least one ballast rail for supporting ballast weight, wherein the at least one ballast rail is coupled to the at least one base rail.

27. A support system according to claim 24, wherein the at least one base rail is formed to support ballast weight.

28. A support system according to claim 24, wherein the support system is provided with at least one connecting profile, and wherein the connecting profile is provided with at least one holding member, wherein the at least one holding member has at least one claw which is formed to hold the connecting profile on at least one of the rails.

29. A support system according to claim 28, wherein the at least one connecting profile is formed to be coupled with at least one of the rails via a translatory movement.

30. A support system according to claim 28, wherein the at least one claw is formed so that it prevents a relative movement between the connecting profile and one of the rails in at least one direction.

31. A support system according to claim 28, wherein the at least one claw extends to the connecting profile at an angle.

32. A support system according to claim 28, wherein the at least one holding member is attached to the upper side or the lower side of the at least one connecting profile.

33. A support system according to claim 28, wherein the holding member is provided with at least two claws which extend towards one another.

34. A support system according to claim 28, wherein the at least one holding member is provided with at least one stop element.

35. A support system according to claim 28, wherein the connecting profile and the at least one rail are part of a connecting system, and wherein the connecting profile and the at least one rail are formed correspondingly to be connectable via a translatory movement.
